(19) United States
(12) Patent Application Publication
(10) Pub. No.: US 2013/0143030 A1
(43) Pub. Date: Jun. 6, 2013

(54) PREPREG AND PRINTED CIRCUIT BOARD COMPROMISING THE SAME

(71) Applicant: c/o Samsung Electro-Mechanics Co., Ltd., Gyeonggi-do (KR)

(72) Inventor: Yoon Shik KIM, Gyeonggi-do (KR)

(73) Assignee: C/O SAMSUNG ELECTRO-MECHANICS CO., LTD., Gyeonggi-do (KR)

(21) Appl. No.: 13/692,834

(22) Filed: Dec. 3, 2012

(30) Foreign Application Priority Data
Dec. 2, 2011 (KR) 10-2011-00128358

(51) Int. Cl. C09D 163/00

(52) U.S. Cl. CPC C09D 163/00
USPC 428/320.2

(57) ABSTRACT

Disclosed herein are a prepreg including an insulating resin composition impregnated into a porous support, and a printed circuit board including the same as an insulating layer. According to the present invention, the porous support used for impregnation of the insulating resin composition has excellent thermal stability and wide surface area, a coefficient of thermal expansion (CTE) of the porous support is not changed according to directivity, and the prepreg has a structure in which fillers included in the insulating resin composition are dispersed between the porous supports, such that the CTE may be efficiently improved. In addition, although damage is generated from the outside, the damage is not enlarged due to adjacent porous supports but is only locally generated and physical properties for pressure load is excellent due to the porous structure, such that damage of the printed circuit board may be reduced.

### CROSS REFERENCE(S) TO RELATED APPLICATIONS

This application claims the benefit under 35 U.S.C. Section 119 of Korean Patent Application Serial No. 10-2011-0128358, entitled “Prepreg and Printed Circuit Board Comprising the Same” filed on Dec. 2, 2011, which is hereby incorporated by reference in its entirety into this application.

### BACKGROUND OF THE INVENTION

1. Technical Field

The present invention relates to a prepreg and a printed circuit board comprising the same.

2. Description of the Related Art

A printed circuit board (PCB) has been positioned as an essential component in almost all electronic industry related fields including information devices as well as electronic products. Particularly, in accordance with the recent trend toward convergence between electronic devices and the slimness and lightness of components, a substrate connected to a small electronic component has significantly become important.

The printed circuit board is divided into a single-sided PCB, a double-sided PCB, and a multi-layer PCB, and a ratio of the multi-layer product is enlarged simultaneously with the development of a technology and dominates the market. Since a newly released embedded PCB, or the like, is based on the multi-layer product, a lamination process is positioned as a key role in a PCB industry.

A general ball grid array (BGA) product is mounted with a semiconductor to thereby be used as a package product. However, problems caused by a difference in coefficients of thermal expansion (CTE) between the BGA product and a semiconductor product have a negative influences on quality of a product. In addition, during a process of manufacturing the BGA product, substrate warpage causes defects such as substrate damage, or the like, at the time of performing a process and becomes a main cause of a scale error and various eccentricities.

Meanwhile, in the printed circuit board, an insulating layer is formed on the substrate including a circuit pattern formed thereon, and generally, a prepreg (PRG) having a structure in which polymer resin compositions are impregnated with a glass fiber is mainly used as the insulating layer.

A currently used prepreg 10 has a structure in which a polymer resin 11, an inorganic filler 12, and a glass fiber 13 are laminated as shown in the following FIG. 1. This structure causes the substrate warpage and the scale error due to a difference in CTE of each layer, and a temperature gradient may be generated in the product since this structure does not meet a trend of heat radiation of a new product such as a metal core, uniformity and a yield of the product may be reduced due to this structure.

The glass fiber configuring the insulating layer is used for giving mechanical strength and scale stability of the insulating layer.

In addition, the polymer resin composition includes a polymer resin for adhesion and interlayer insulation of a copper foil and the glass fiber, a hardener hardening (cross-linking) the resin to increase physical/chemical strength, a flame retardant for giving flame resistance, and the inorganic filler for giving mechanical strength, scale stability, and flame resistance.

The insulating layer is made of prepreg, which is in a semi-hardened state, and in order to solve problems due to a difference in CTE of this prepreg, research into technologies of improving the polymer resin, improving the inorganic filler, and improving the glass fiber have been conducted.

Among these researches, the researches into technologies for improving the inorganic filler and the glass fiber have been mainly conducted, but the inorganic filler has a negative influence on an optical/mechanical drill, such that there was a limitation in content or a kind of inorganic filler.

In the case of the glass fiber, a technology of improving a property of glass and a structure of the fiber and reducing a diameter of the glass fiber to reduce the CTE, maintain the mechanical strength of the insulating layer, which is a conventional function, and maintain scale stability and elasticity (shape elasticity and volume elasticity) stability, or the like, has been tried, but was a limitation due to processing technology.

In the case of prepreg manufactured by using the existing glass fiber as a support, a coefficient of thermal expansion is changed according to a kind of glass fiber and a direction of a fabric, such that problems such as warpage of the substrate, a scale error, or the like, may occur. Therefore, the substrate may have compression resistance but is vulnerable to warpage, torsion, or tension.

Further, in the case of the glass fiber, in order to minimize a difference in the CTE, a content of the inorganic filler in the insulating resin composition is limited, and a problem that the inorganic fillers are lumped with each other is still present. Therefore, a method of solving this problem has been required.

### SUMMARY OF THE INVENTION

The present invention is proposed to solve the existing problems caused by a difference in coefficients of thermal expansion between a support and an insulating resin composition of an insulating layer of a printed circuit board used in a prepreg state in which the existing insulating resin composition is impregnated into the support such as glass fiber, or the like. An object of the present invention is to provide a prepreg capable of improving the problem due to the difference in coefficients of thermal expansion and having excellent physical properties without warpage of a substrate, torsion thereof, or the like.

In addition, another object of the present invention is to provide a printed circuit board including an insulating layer made of the prepreg.

Further, another object of the present invention is to provide a laminate including the insulating layer made of the prepreg.

According to an exemplary embodiment of the present invention, there is provided a prepreg including an insulating resin composition impregnated into a porous support.

The porous support may have a specific surface area of 200 to 2000 mm²/g

A size of a pore of the porous support may be 80 μm or less. The porous support may be made of at least one kind selected from at least one porous inorganic material selected from a group consisting of aerogel, silica, fused silica, glass, alumina, platinum, nickel, titania, zirconia, ruthenium, cobalt, and a combination thereof; and at least one porous polymer selected from a group consisting of urea resin, phenol resin, polystyrene resin, and a combination thereof.

The insulating resin composition may include a base resin and a filler.

The base resin may be at least one epoxy resin selected from at least one phenol based glycidyl ether type epoxy resin selected from a group consisting of phenol novolac type epoxy resins, cresol novolac type epoxy resin, naphthol modified novolac type epoxy resin, bisphenol A type epoxy resin, bisphenol F type epoxy resin, biphenyl type epoxy resin, and triphenyl type epoxy resin; dicyclopentadiene type epoxy resins having a dicyclopentadiene skeleton; naphthalene type epoxy resins having a naphthalene skeleton; dihydroxy benzopyran type epoxy resins; glycidylamine type epoxy resin; triphenylmethane type epoxy resins; tetraphenylethane type epoxy resins, and mixture resins thereof.

The porous support may include a filler.

A content of the base resin may be 10 to 80 weight % in the insulating resin composition.

According to another exemplary embodiment of the present invention, there is provided a printed circuit board including an insulating layer made of the prepreg as described above.

The insulating layer may be an insulating film.

According to another exemplary embodiment of the present invention, there is provided a laminate including: an insulating layer made of the prepreg as described above; and a copper foil or a polymer film that is formed on at least one of the upper and lower surfaces of the insulating layer.

### BRIEF DESCRIPTION OF THE DRAWINGS

FIG. 1 is a view showing a structure of a prepreg, which is an insulating layer;

FIG. 2 is a structure of a prepreg according to an exemplary embodiment of the present invention;

FIG. 3 is view showing an example of using the prepreg according to the present invention; and

FIG. 4 is a view of a copper clad laminate including the prepreg insulating layer according to the exemplary embodiment of the present invention.

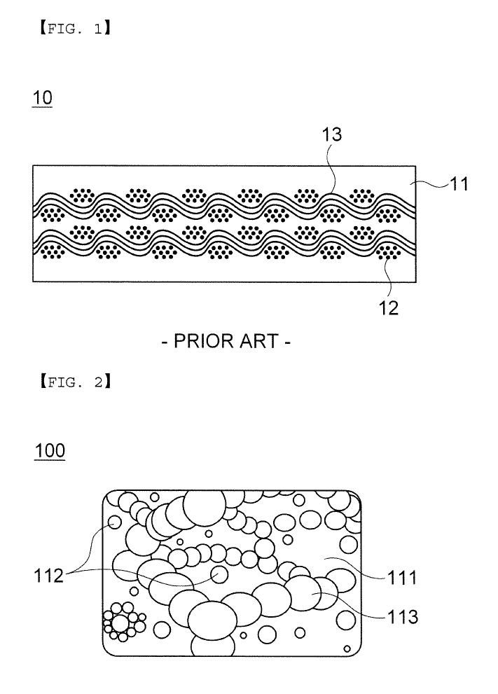

### DESCRIPTION OF THE PREFERRED EMBODIMENTS

Hereinafter, exemplary embodiments of the present invention will be described in detail with reference to the accompanying drawings.

Terms used in the present specification are used in order to describe specific exemplary embodiments rather than limiting the present invention. Unless explicitly described to the contrary, a singular form includes a plural form in the present specification. Terms “comprise” and variations such as “comprise” and/or “comprising” used in the present specification will imply the existence of stated shapes, numbers, steps, operations, elements, and/or groups thereof, but does not include the exclusion of any other shapes, numbers, steps, operations, elements, and/or groups thereof.

The present invention relates to a prepreg formed by impregnating an insulating resin composition into a porous support, and a printed circuit board including the prepreg as an insulating layer. The prepreg 100 according to the present invention is shown in FIG. 2.

The prepreg 100 according to the present invention has a structure in which an insulating resin composition including a base resin 111 and fillers 112 are impregnated into a porous support 113.

Since the porous support 113 according to the present invention has a porous structure in which a plurality of pores are included as shown in FIG. 2, a surface area thereof is wide. For example, the porous support 113 according to the present invention may have a specific surface area of 200˜2000 m²/g.

In the case in which the specific surface area of the porous support 113 is smaller than 200 m²/g, heat resistance may be insufficient, and in the case in which the specific surface area of the porous support 113 is larger than 2000 m²/g, the mechanical properties may be deteriorated.

Further, the porous support 113 according to the present invention has excellent thermal stability, and a coefficient of thermal expansion (CTE) is not changed according to directivity. Therefore, problems such as warpage of the substrate, a scale error, or the like, generated due to the CTE changed according to a direction of a fabric in glass fibers used as the support in the related art may be minimized, such that the porous support 113 may be preferably used. In addition, in the case of the glass fiber, a content of fillers is limited in the insulating resin composition in order to minimize a difference in CTE, and a phenomenon that fillers are lumped with each other is generated.

However, in the case of using the porous support according to the present invention, the fillers 112 may be injected between pores of the porous support 113 as shown in FIG. 2, such that a problem that the fillers are lumped with each other may be minimized.

That is, according to the present invention, the filler may be included in the insulating resin composition and included in the insulating resin composition and the porous support in advance. In the case in which the filler is included in the porous support, the filler may be distributed between the pores of the porous support in advance by a spray injection method, or the like. In this case, the filler is uniformly distributed, such that the problem that the fillers are lumped with each other may be solved.

It may be preferable in view of injection and distribution of the filler according to the impregnation that the pore included in the porous support 113 according to the present invention has a size of 80 μm or less, preferably, 0.01 to 30.00 μM.

The porous support according to the present invention having the above-mentioned characteristics may be made of at least one kind selected from at least one porous inorganic material selected from a group consisting of aerogel, silica, fused silica, glass, alumina, platinum, nickel, titania, zirconia, ruthenium, cobalt, and a combination thereof and at least one porous polymer selected from a group consisting of urea resin, phenol resin, polystyrene resin, and a combination thereof, and among them, aerogel is most preferable.

That is, since the porous support 113 according to the present invention may have balanced distribution to have excellent physical properties and be simply exchanged with the support used in the art, the prepreg may be easily manufactured.

In addition, in the case in which an insulating resin composition is impregnated into the uniformly distributed porous support 113 to manufacture the prepreg 100 as in the present invention, the same effect may be obtained as that of the present invention.

For example, in the case of dispersing porous materials in an insulating resin composition to manufacture an insulating layer film and use the manufactured insulating film in a printed circuit board, since it is not easy to disperse the porous material in the insulating resin composition, the porous material may not be used as a material due to non-uniform distribution, and it may be difficult to change a shape of the porous material.

However, it may be obviously recognized by those skilled in the art that in the case of impregnating the insulating resin composition into the porous support 113 according to the present invention to manufacture the prepreg 110, hardening the manufactured prepreg 100 to manufacture an insulating film, and using the insulating film in the printed circuit board, the same effect may be obtained as that of the present invention.

Meanwhile, the insulating resin composition according to the present invention may include the base resin and the filler. The insulating resin composition is used for interlayer insulation, and a polymer resin used in the existing insulating layer and having excellent insulation characteristics may be used as the base resin.

According to the present invention, an epoxy resin having various shapes may be used as the base resin. For example, the epoxy resin may be at least one kind selected from at least one phenol based glycidyl ether type epoxy resin selected from a group consisting of phenol novolac type epoxy resins, cresol novolac type epoxy resin, naphthol modified novolac type epoxy resin, bisphenol A type epoxy resin, bisphenol F type epoxy resin, biphenyl type epoxy resin, and triphenyl type epoxy resin; dicyclopentadiene type epoxy resins having a dicyclopentadiene skeleton; naphthalene type epoxy resins having a naphthalene skeleton; dihydroxy benzopyran type epoxy resins; glycidylamine type epoxy resin; triphenylmethane type epoxy resins; tetraphenylethane type epoxy resins, and mixture resins thereof.

More specifically, the epoxy resin may be N,N,N′,N′-tetraglycidyl-4,4′-methylenebisbenzenamine, polyglycidyl ether of o-cresol-formaldehyde novolac, or a mixture thereof.

A content of the epoxy resin in the entire composition for a circuit board may be preferably 10 to 80 weight %, and in the case in which the content is in the above range, adhesive force between the insulating composition and a metal such as copper, or the like, may be improved, and chemical resistance, thermal characteristics, and scale stability may be improved.

In addition, the filler according to the present invention may include an organic filler and inorganic filler and include at least one inorganic filler selected from natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, silicon nitride, silicon oxide, aluminum titanate, barium titanate, barium strontium titanate, aluminum oxide, alumina, clay, kaolin, talc, calcined clay, calcined kaolin, calcined talc, mica, short glass fibers and mixtures thereof, but is not particularly limited thereto.

An example of the organic filler includes epoxy resin powder, melamine resin powder, urea resin powder, benzoguanamine resin powder, styrene resin, and the like, but is not limited thereto.

In addition, the insulating resin composition according to the present invention may further include additives such as a filler, a softener, a plasticizer, an antioxidant, a flame retardant, a flame retardant adjuvant, a lubricant, an antistatic agent, a colorant, a heat stabilizer, a light stabilizer, a UV absorbent, a coupling agent, a precipitation preventing agent, or the like, as long as physical properties of the prepreg of the present invention is not deteriorated, and a kind and a content of the additive is not particularly limited.

The insulating resin composition for a printed circuit board according to the exemplary embodiment of the present invention may be prepared by blending the components by various methods such as mixing at room temperature, melt mixing, or the like.

The prepreg according to the present invention may be formed by mixing the insulating resin composition and the porous support with each other. More specifically, the prepreg may be manufactured by applying or impregnating the insulating resin composition into the porous support, hardening the resultant, and then removing the solvent. An example of the impregnation method includes a dip coating method, a roll coating method, or the like, but is not limited thereto.

A content of the impregnated insulating resin composition may be 100 to 30,000 weight % based on 100 weight % of the porous support. When the content of the impregnated insulating resin composition is lower than 100 weight %, impregnation is not performed, and when the content is higher than 30,000 weight %, thermal effect of the porous support may be deteriorated.

The insulating resin composition is impregnated in the above range, mechanical strength and scale stability of the prepreg may be improved. In addition, adhesion of the prepreg is improved, such that close adhesion with other prepregs may be improved.

Further, the porous support may include the filler. For example, after the filler is dispersed between the pores of the porous support in advance, the insulating resin composition may be impregnated into the filler dispersed porous support.

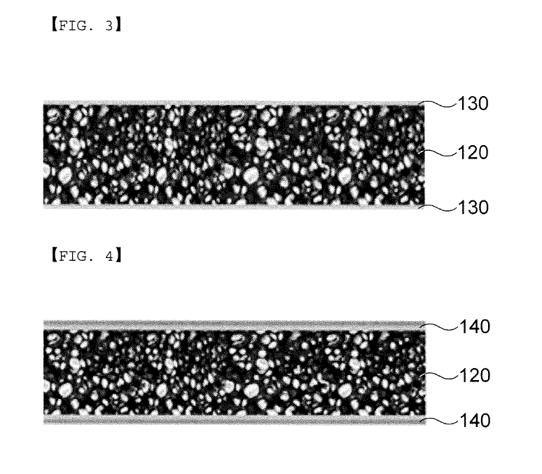

The following FIG. 3 is a view showing a printed circuit board according to the exemplary embodiment of the present invention. The printed circuit board may include an insulating layer 120 made of the prepreg; and a circuit pattern 130 formed on one side or both sides of the insulating layer 120. According to the exemplary embodiment of the present invention, the insulating layer may be an insulating film.

FIG. 4 is a cross-sectional view schematically showing a copper clad laminate (CCL) according to the exemplary embodiment of the present invention, and the printed circuit board according to the exemplary embodiment of the present invention may be formed by stacking the CCL.

Referring to FIG. 4, the CCL may include the insulating layer 120 and copper foils 140 formed on both sides of the insulating layer. In addition, although not shown, the copper foil may be formed on only one side of the insulating layer.

As described above, the insulating layer may be preferably made of the prepreg formed by impregnating the insulating resin composition according to the exemplary embodiment of the present invention into the porous support.

The CCL may be formed by forming the copper foil 140 on the insulating layer 120 and then performing thermal treatment. The circuit pattern may be formed by patterning the copper foil 140 of the CCL.

In addition, the printed circuit board may be formed to include a polymer film rather than the copper foil 140.

The insulating layer made of prepreg according to the present invention has a conductor circuit pattern formed thereon, such that the insulating layer may be used in various printed circuit boards requiring the interlayer insulation. That is, the printed circuit board is divided into a mother board for mounting components thereon and an integrated circuit (IC) substrate for mounting semiconductors thereon and may be divided into a rigid substrate using epoxy resin, phenol resin, and bismaleimide triazine (BT); a flexible substrate using polyimide; a special substrate such as a metal core substrate, a ceramic core substrate, a rigid-flexible substrate, an embedded substrate, an optical substrate, according to a material. Further, the printed circuit board (PCB) may be divided into a single-sided PCB, a double-sided PCB, and a multi-layer PCB according to the number of layer and be divided into a ball grid array (BGA), a pin grid array (PGA), and a land grid array (LGA) according to a shape. The insulating layer made of the prepreg may be used in the above-mentioned printed circuit board for various purposes.

According to the present invention, the porous support used for impregnation of the insulating resin composition has excellent thermal stability and wide surface area, a coefficient of thermal expansion (CTE) of the porous support is not changed according to directivity, and the prepreg has a structure in which fillers included in the insulating resin composition are dispersed between the porous supports, such that the CTE may be efficiently improved.

In addition, although damage is generated from the outside, the damage is not enlarged due to adjacent porous supports but is only locally generated and physical properties for pressure load is excellent due to the porous structure, such that damage of the printed circuit board may be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A prepreg comprising an insulating resin composition impregnated into a porous support.

2. The prepreg according to claim 1, wherein the porous support has a specific surface area of 200 to 2000 m²/g.

3. The prepreg according to claim 1, wherein a size of a pore of the porous support is sop or less.

4. The prepreg according to claim 1, wherein the porous support is made of at least one kind selected from at least one porous inorganic material selected from a group consisting of aerogel, silica, fused silica, glass, alumina, platinum, nickel, titania, zirconia, ruthenium, cobalt, and a combination thereof; and at least one porous polymer selected from a group consisting of urea resins, phenol resins, polystyrene resins, and a combination thereof.

5. The prepreg according to claim 1, wherein the insulating resin composition includes a base resin and a filler.

6. The prepreg according to claim 5, wherein the base resin is at least one epoxy resin selected from at least one phenol based glycidyl ether type epoxy resin selected from a group consisting of phenol novolac type epoxy resins, cresol novolac type epoxy resins, naphthol modified novolac type epoxy resins, bisphenol A type epoxy resins, bisphenol F type epoxy resins, biphenyl type epoxy resins, and triphenyl type epoxy resins;
dicyclopentadiene type epoxy resins having a dicyclopentadiene skeleton;
naphthalene type epoxy resins having a naphthalene skeleton;
dihydroxy benzopyran type epoxy resins;
glycidylamine type epoxy resins;
triphenylmethane type epoxy resins;
tetraphenylethane type epoxy resins, and mixture resins thereof.

7. The prepreg according to claim 1, wherein the porous support includes a filler.

8. The prepreg according to claim 5, wherein a content of the base resin is 10 to 80 weight % in the insulating resin composition.
